(19) United States
(12) Patent Application Publication
(10) Pub. No.: US 2013/0060452 A1
(43) Pub. Date: Mar. 7, 2013

(54) CONTROL APPARATUS AND CONTROL METHOD FOR INTERNAL COMBUSTION ENGINE

(71) Applicants: Masayuki SARUWATARI, Isesaki-shi (JP); Nobuhiko Matsuo, Isesaki-shi (JP); Tomoyuki Murakami, Isesaki-shi (JP)

(72) Inventors: Masayuki SARUWATARI, Isesaki-shi (JP); Nobuhiko Matsuo, Isesaki-shi (JP); Tomoyuki Murakami, Isesaki-shi (JP)

(73) Assignee: Hitachi Automotive Systems, Ltd.

(21) Appl. No.: 13/470,387

(22) Filed: May 14, 2012

(30) Foreign Application Priority Data
Sep. 6, 2011 (JP) 2011-193769

(51) Int. Cl. F02D 3/00

(52) U.S. Cl. 701/105; 701/103

(57) ABSTRACT

Control apparatus and method for internal combustion engine includes a fuel injection valve that injects fuel into an intake pipe at the upstream side of intake valves. When a deposition amount VDEPO of the intake valves is estimated, and becomes greater than a second threshold value SL2, the current mode switches to a cleaning mode to clean deposits away by increasing the amount of fuel adhering to the intake valves and changing the fuel injected by the fuel injection valve to a fuel with a higher cleaning performance, or one of increasing and changing. The increasing of the amount of fuel adhering to the intake valves is achieved by the changing of the injecting timing, the increasing of the fuel pressure, the switching of the fuel injection valve, and the like. Furthermore, changing of the fuel with the higher cleaning performance is achieved by switching to additive-containing fuel.

### BACKGROUND OF THE INVENTION

1. Field of the Invention

The present invention relates to a control apparatus and a control method for an internal combustion engine with a fuel injection valve that injects fuel into an intake pipe at the upstream side of an intake valve.

2. Description of Related Art

Japanese Laid-Open Patent Application No. 2007-247425 discloses a cylinder direct injection engine in which fuel is injected into an intake pipe when deposits in an intake valve must be removed. The fuel which is injected into the intake pipe permeates into the deposits of the intake valve, so that the adhesion of the deposits is weakened and the deposits are removed from the intake valve.

However, in an engine in which fuel is injected into an intake pipe at the upstream side of an intake valve, fine atomization of fuel is required in order to achieve high combustion efficiency. For example, Japanese Laid-Open Patent Application No. 2003-336562 discloses a fuel injection valve that applies a turning force to fuel injected from an injection hole so as to promote the fine atomization of fuel.

However, when the fuel is highly atomized, the amount of fuel adhering to the intake valve is reduced, so that the ability to remove deposits is reduced.

For this reason, in an engine in which fuel is injected into the intake pipe, when high combustion efficiency is achieved by the fine atomization of fuel, a problem arises in that the amount of deposits in the intake valve increases.

### SUMMARY OF THE INVENTION

Therefore, it is an object of the invention to provide a control apparatus and a control method capable of obtaining high combustion efficiency in an internal combustion engine in which fuel is injected into an intake pipe at the upstream side of an intake valve and suppressing the amount of deposition at the intake valve.

In order to achieve the abovementioned object, according to an aspect of the invention, there is provided a control apparatus for an internal combustion engine including an intake valve and a fuel injection valve injecting fuel into an intake pipe at the upstream side of the intake valve. The control apparatus includes: an estimation unit that estimates a deposition amount on the intake valve based on an operation state of the internal combustion engine; and a control unit that improves a capability of cleaning away deposits using the fuel in accordance with an increase in deposition amount estimated by the estimation unit.

Furthermore, according to another aspect of the invention, there is provided a control method for an internal combustion engine including an intake valve and a fuel injection valve injecting fuel into an intake pipe at the upstream side of the intake valve. The control method includes: estimating a deposition amount of the intake valve based on an operation state of the internal combustion engine; and improving deposit cleaning away performance using the fuel in accordance with an increase in the deposit amount.

Other objects and features of aspects of the present invention will be understood from the following description with reference to the accompanying drawings.

### BRIEF DESCRIPTION OF THE DRAWINGS

FIG. 1 is a systematic diagram illustrating an internal combustion engine of an embodiment of the invention;

FIG. 2 is a flowchart illustrating a deposit removing process of the embodiment of the invention;

FIG. 3 is a flowchart illustrating a deposit amount estimating process of the embodiment of the invention;

FIG. 4 is a diagram illustrating a system that switches a fuel injection valve so as to clean deposits in the embodiment of the invention; and

FIG. 5 is a diagram illustrating a system that switches fuel so as to clean away deposits in the embodiment of the invention.

### DESCRIPTION OF THE PREFERRED EMBODIMENTS

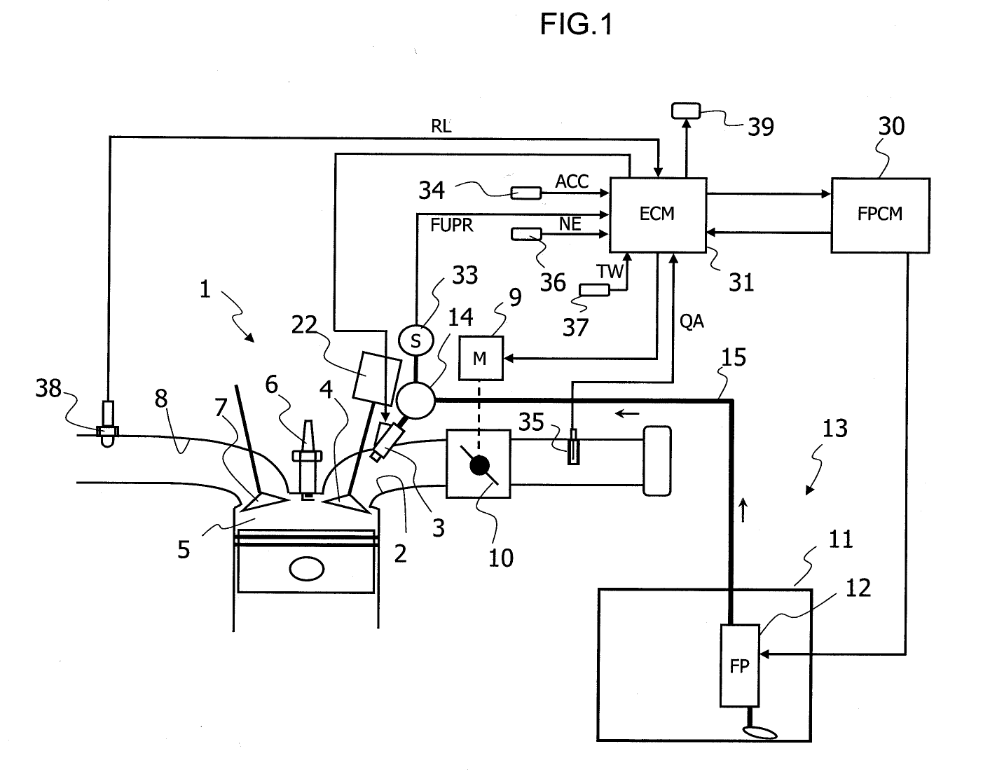

FIG. 1 is a systematic diagram illustrating an internal combustion engine for a vehicle that adopts a control apparatus and a control method according to an aspect of the present invention.

In FIG. 1, an internal combustion engine 1 for a vehicle includes a fuel injection valve 3 that is installed in an intake pipe 2.

Fuel injection valve 3 is directed toward an umbrella portion of intake valves 4 and injects fuel into intake pipe 2.

The fuel which is injected by fuel injection valve 3 is drawn into a combustion chamber 5 together with air when intake valves 4 are opened at an intake stroke. The fuel inside combustion chamber 5 is ignited and burned by the spark ignition using a spark plug 6. The combustion gas inside combustion chamber 5 is discharged to an exhaust pipe 8 when exhaust valves 7 are opened at an exhaust stroke.

The degree of opening of intake valves 4 may be changed by a variable valve mechanism 22.

An electronic control throttle 10 is disposed on the upstream side of a portion at which fuel injection valve 3 of intake pipe 2 is disposed. Electronic control throttle 10 is driven by a throttle motor 9.

Furthermore, a fuel supply device 13 pressure-feeds the fuel in a fuel tank 11 to fuel injection valve 3 by a fuel pump 12.

Fuel supply device 13 includes: fuel tank 11, fuel pump 12, a gallery pipe 14, and a main pipe 15.

Fuel pump 12 is an electric pump that drives a pump impeller using a motor, and is disposed in fuel tank 11.

One end of main pipe 15 is connected to an outlet of fuel pump 12, and the other end of main pipe 15 is connected to gallery pipe 14. Furthermore, fuel injection valve 3 which is provided for each cylinder engine is connected to gallery pipe 14.

Furthermore, a pressure regulator may be provided which opens a valve when the pressure of the fuel inside main pipe 15 becomes greater than the predetermined lowest pressure and returns the fuel inside main pipe 15 to fuel tank 11. Furthermore, a jet pump may be provided which transfers fuel by using the flow of the fuel which is returned from the pressure regulator.

As a control unit that controls internal combustion engine 1, an engine control module (ECM) 31 with a microcomputer is provided.

Furthermore, as a control unit that controls fuel pump 12, a fuel pump control module (FPCM) 30 with a microcomputer is provided.

ECM 31 and FPCM 30 are configured to communicate with each other. Then, an instruction value of a duty ratio in the duty control of fuel pump 12 and the like is transmitted from ECM 31 to FPCM 30.

Furthermore, the duty ratio (%) of the present invention indicates the on-time ratio for each cycle, and the voltage applied to fuel pump 12 increases as the duty ratio increases.

Furthermore, one control unit that has both the function of ECM 31 and the function of FPCM 30 may be provided.

Output signals output from various sensors are input to ECM 31.

As various sensors, a fuel pressure sensor 33 that detects a fuel pressure FUPR inside gallery pipe 16, an accelerator opening degree sensor 34 that detects an opening degree ACC of an accelerator pedal (not illustrated), an air flow sensor 35 that detects an air intake amount QA of internal combustion engine 1, a rotation sensor 36 that detects a rotation speed NE of internal combustion engine 1, a water temperature sensor 37 that detects a temperature TW of cooling water of internal combustion engine 1, an oxygen sensor 38 that detects whether an air-fuel ratio is rich or lean with respect to a theoretical air-fuel ratio based on the oxygen concentration in exhaust air, and the like are provided.

Furthermore, an air-fuel ratio sensor which generates an output with the air-fuel ratio may be provided instead of oxygen sensor 38.

ECM 31 calculates a basic injection pulse width TP based on air intake amount QA and engine rotation speed NE, and corrects basic injection pulse width TP in accordance with fuel pressure FUPR at that time. Furthermore, ECM 31 calculates an air-fuel ratio feedback correction coefficient LAMBDA which is used to cause the air-fuel ratio to approach the target air-fuel ratio, based on the output of oxygen sensor 38. Then, ECM 31 corrects basic injection pulse width TP corrected in accordance with fuel pressure FUPR, using air-fuel ratio feedback correction coefficient LAMBDA or the like so as to calculate a final injection pulse width TI.

Here, ECM 31 outputs an injection pulse signal of injection pulse width TI to fuel injection valve 3 at the injecting timing, and controls the fuel injecting amount and the injecting timing by fuel injection valve 3.

Furthermore, ECM 31 calculates the ignition timing based on basic injection pulse width TP and engine rotation speed NE representing a load of internal combustion engine 1, and controls the supply of a current to an ignition coil (not illustrated) so as to perform the spark discharge using spark plug 6 at the ignition timing.

Moreover, ECM 31 calculates the target opening degree of electronic control throttle 10 based on accelerator opening degree ACC and the like, and controls throttle motor 9 based on the target opening degree.

In addition, ECM 31 calculates a target fuel pressure TGFUPR based on an engine operation condition such as an engine load, an engine rotation speed, and an engine temperature, and calculates the duty ratio in the duty control of fuel pump 12 so that fuel pressure FUPR detected by fuel pressure sensor 33 approaches target fuel pressure TGFUPR.

Then, ECM 31 outputs a signal instructing the calculated duty ratio to FPCM 30, and FPCM 30 controls the supply of a current to fuel pump 12 based on the instructed duty ratio.

Incidentally, gummy matter which is contained in fuel, may adhere to the umbrella portion and the like of intake valves 4, and the adhered gummy matter may solidify as temperature decreases inside the intake pipe and is gradually deposited therein

Here, when the fuel which is injected from fuel injection valve 3 adheres to intake valves 4, the fuel permeates into the deposit so that the adhesion of the deposit is weakened, thereby removing the deposit.

On the other hand, in order to improve combustion characteristics or exhaust characteristics, fuel needs to be sprayed as fine particles. However, when the particle diameter of the fuel to be sprayed is small, the amount of fuel that adheres to intake valves 4 decreases, so that the deposit cleaning performance is degraded.

Therefore, ECM 31 controls the deposit cleaning process so that an increase in the amount of deposit at intake valves 4 is suppressed and combustion characteristics or exhaust characteristics are improved as much as possible.

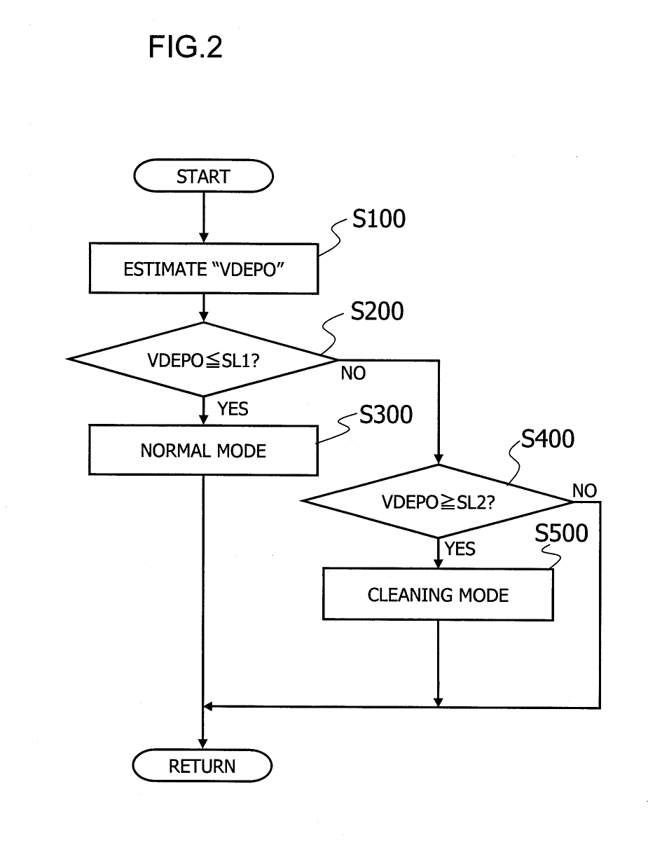

In the description below, the cleaning control using ECM 31 will be described according to the flowchart of FIG. 2. Furthermore, the routine illustrated in the flowchart of FIG. 2 is performed at every predetermined time by ECM 31.

First, in step S100, deposition amount VDEPO in intake valves 4 is estimated based on an engine operation state such as engine load and engine rotation speed.

Furthermore, deposition amount VDEPO estimated in step S100 may be provided as data that represents a deposition degree or a deposition progress degree.

In next step S200, deposition amount VDEPO estimated in step S100 is compared with a first threshold value SL1.

First threshold value SL1 is the maximum allowable amount of deposition amount VDEPO. Accordingly, when deposition amount VDEPO is equal to or less than first threshold value SL1, an intake operation or the like in internal combustion engine 1 is not affected even when the deposit is left as it is.

Accordingly, in step S200, when it is determined that deposition amount VDEPO is equal to or less than first threshold value SL1, the process of cleaning the deposit on intake valves 4 is not required, and the current process proceeds to step S300 so as to select a normal mode.

The normal mode indicates a state in which cleaning mode that performs an active cleaning process is canceled, and is a control mode in which fuel injection or the like of fuel injection valve 3 is performed by prioritizing combustion characteristics, fuel efficiency, exhaust characteristics, output, and the like compared to the sediment cleaning process.

On the other hand, in step S200, when it is determined that deposition amount VDEPO becomes greater than first threshold value SL1, the current process proceeds to step S400 so as to determine whether deposition amount VDEPO is equal to or greater than a second threshold value SL2.

Second threshold value SL2 is a value which is greater than first threshold value SL1, and is a minimal value of deposition amount VDEPO which indicates a state in which the deposit cleaning process needs to be performed. Accordingly, when the deposition amount becomes greater than second threshold value SL2, there is a possibility that the opening area of intake valves 4 may be narrowed by the deposit, and it may be determined that the deposit cleaning process needs to be performed.

Here, when deposition amount VDEPO is greater than first threshold value SL1, but is less than second threshold value SL2, it is determined that the deposit cleaning process does not need to be performed immediately even if it is a level that indicates a state in which the deposit cleaning process needs to be performed based on deposition amount VDEPO, and the normal mode is maintained by bypassing the cleaning mode of step S500.

On the other hand, when deposition amount VDEPO becomes equal to or greater than second threshold value SL2, it is determined that the deposit cleaning process needs to be performed, and the current process proceeds to step S500 so as to switch from the normal mode to the cleaning mode. The cleaning mode will be described in more detail later, but as an example, it is the mode that cleans the deposit by increasing the amount of fuel adhering to intake valves 4 compared to the normal mode.

Furthermore, in step S200, the normal mode may be switched to the cleaning mode at a timing when it is determined that deposition amount VDEPO becomes greater than first threshold value SL1.

The cleaning mode of step S500 is maintained until a predetermined cleaning time necessary for cleaning the deposit elapses, deposition amount VDEPO is reset to an initial value at a time point when the cleaning time elapses, and then the cleaning mode is returned to the normal mode.

Furthermore, when deposition amount VDEPO is sequentially decreased according to, for example, the cleaning mode maintaining time and deposition amount VDEPO becomes less than first threshold value SL1, the cleaning mode may be returned to the normal mode.

Furthermore, in the estimation of deposition amount VDEPO, for example, deposition amount VDEPO may be subtracted or the updating of deposition amount VDEPO may be stopped based on an operation condition in which the amount of fuel adhering to intake valves 4 increases.

Furthermore, when the cleaning mode is performed in step S500, for example, an alarm lamp 39 which is installed near a driver's seat of a vehicle is turned on, which may warn a driver that the deposition cleaning process of intake valves 4 is being performed.

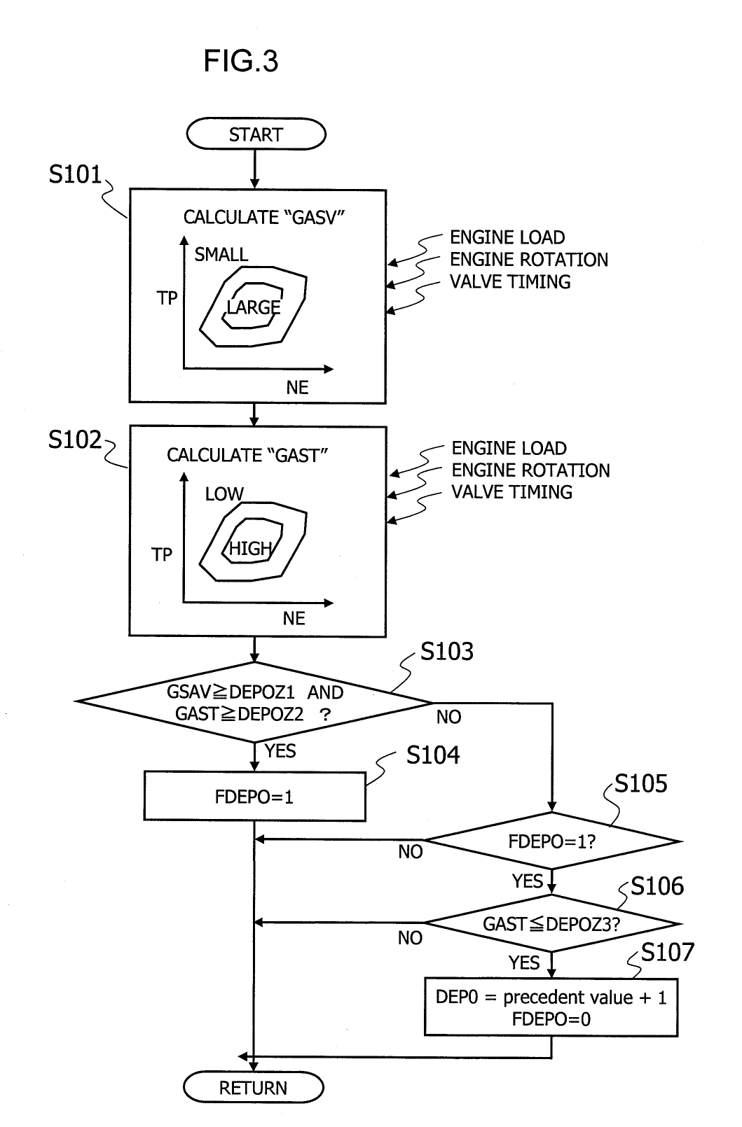

Here, the process of estimating sediment amount VDEPO in step S100 will be described in detail according to the flowchart of FIG. 3.

In step S101, a gas amount GASV which indicates that gas is blown back to intake pipe 2 through intake valves 4 is calculated based on the load of internal combustion engine 1, engine rotation speed NE, and the valve timing of intake valves 4.

Here, the load of internal combustion engine 1 may be represented as, for example, a basic injection pulse width TP.

With regard to engine load TP and engine rotation speed NE, as illustrated in FIG. 3, an area is present in which blown-back gas amount GASV is the largest at a region with middle load and middle rotation, and there is a tendency for blown-back gas amount GASV to decrease as it moves away from the maximal gas amount area. Furthermore, when variable valve mechanism 22 changes the valve timing of intake valves 4, there is a tendency for blown-back gas amount GASV to increase as the valve timing of intake valves 4 is advanced.

Furthermore, when the valve timing of intake valves 4 is fixed, blown-back gas amount GASV may be calculated based on engine load TP and engine rotation speed NE.

In next step S102, blown-back gas temperature GAST is calculated based on the load of internal combustion engine 1, engine rotation speed NE, and the valve timing of intake valves 4.

With regard to engine load TP and engine rotation speed NE, as illustrated in FIG. 3, an area is present in which gas temperature GAST is the highest at a region with middle load and middle rotation, and there is a tendency for gas temperature GAST to increase as it moves away from the maximal temperature area. Furthermore, when variable valve mechanism 22 changes the valve timing of intake valves 4, there is a tendency for gas temperature GAST to increase as the valve timing of intake valves 4 is advanced.

Furthermore, when the valve timing of intake valves 4 is fixed, blown-back gas temperature GAST may be calculated based on engine load TP and engine rotation speed NE.

In step S103, it is determined whether blown-back gas amount GASV is equal to or greater than threshold value DEPOZ1 and blown-back gas temperature GAST is equal to or greater than threshold value DEPOZ2.

That is, the adhering of gummy matter or the like to intake valves 4 occurs when the blown-back amount of a gas including fuel toward intake pipe 2 increases, but even when blown-back gas amount GASV is large, the adhering does not occur when the temperature is low. Therefore, the minimal amount of blown-back gas amount GASV and the minimal value of blown-back gas temperature GAST which causes the adhering of gummy matter to intake valves 4 are obtained in advance, and threshold values DEPOZ1 and DEPOZ2 are set based on these parameters. Then, when GASV≧(is equal to or greater than) DEPOZ1 and GAST≧(is equal to or greater than) DEPOZ2, it is determined that a condition in which the gummy matter adheres to intake valves 4 is satisfied.

In step S103, when it is determined that GASV≧(is equal to or greater than) DEPOZ1 and GAST≧(is equal to or greater than) DEPOZ2, the current process proceeds to step S104 so as to set 1, which is a value representing the state in which the adhering condition is satisfied, with respect to a flag FDEPO which indicates whether the gummy matter adhering condition is satisfied.

On the other hand, in step S103, when it is determined that GASV≧(is equal to or greater than) DEPOZ1 and GAST≧(is equal to or greater than) DEPOZ2 are not satisfied, that is, GASV<(is less than) DEPOZ1 and/or GAST<(is less than) DEPOZ2, the current process proceeds to step S105 so as to determine whether 1 is set with respect to flag FDEPO.

When 0 is set with respect to flag FDEPO, this is not a condition that the deposition amount of intake valves 4 increases, whereby the routine is ended as it is.

On the other hand, when 1 is set with respect to flag FDEPO, this indicates a case in which gummy matter or the like adheres to intake valves 4, and when gummy matter is solidified with a decrease in temperature, the gummy matter remains as deposit in intake valves 4.

Therefore, in step S105, when it is determined that 1 is set with respect to flag FDEPO, the current process proceeds to step S106 so as to determine whether blown-back gas temperature GAST is equal to or less than a threshold value DEPOZ3. That is, it is determined whether blown-back gas temperature GAST becomes less than threshold value DEPOZ3 after that GASV≧(is equal to or greater than) DEPOZ1 and GAST≧(is equal to or greater than) DEPOZ2 were satisfied.

Threshold value DEPOZ3 is a temperature which is lower than threshold value DEPOZ2, and is set around a temperature at which adhering matter such as gummy matter starts to be solidified.

When blown-back gas temperature GAST is higher than threshold value DEPOZ3, even when gummy matter or the like adheres to intake valves 4, the gummy matter is not solidified as deposits, and hence the routine is ended as it is.

On the other hand, when blown-back gas temperature GAST is less than threshold value DEPOZ3, the gummy matter adhering to intake valves 4 is solidified as deposits. For this reason, the current process proceeds to step S107 so as to increase deposition amount DEPO by one step from the precedent value.

That is, when the blown-back gas amount increases and becomes higher than the temperature at that time, it is estimated that gummy matter or the like adheres to intake valves 4. When the temperature decreases later, deposition amount DEPO is updated to an amount in which the deposition amount increases by one step.

Furthermore, the unit that estimates the deposition amount of intake valves 4 is not limited to the above-described unit.

For example, simply, deposition amount DEPO may be updated by estimating that the deposition occurs in intake valves 4 whenever a predetermined time elapses during the operation of internal combustion engine 1, the accumulation value of the intake air amount of internal combustion engine 1 reaches a predetermined value, or internal combustion engine 1 is operated in a specific operation area. Here, when deposition amount DEPO is updated every predetermined time during the operation of internal combustion engine 1, the normal mode is consequently switched to the cleaning mode every predetermined operation time.

Next, the cleaning mode of step S500 in the flowchart of FIG. 2 will be described in detail.

The cleaning mode is a mode in which the amount of fuel adhering to intake valves 4 increases compared to the normal mode. When the fuel which is injected from fuel injection valve 3 adheres to intake valves 4 and permeates into the deposition of intake valves 4, the deposition adhesion to intake valves 4 is weakened, so that the deposit may be cleaned away. Accordingly, when the amount of fuel adhering to intake valves 4 increases, the deposit cleaning performance is improved.

In the normal mode, when it is set so that fuel adheres to intake valves 4 to an extent in which the deposit may be sufficiently cleaned away, combustion characteristics or exhaust characteristics degrade. Accordingly, in the normal mode, the amount of fuel adhering to intake valves 4 is suppressed to be low by prioritizing combustion characteristics or exhaust characteristics over the deposition cleaning process.

On the other hand, in the cleaning mode, the amount of fuel adhering to intake valves 4 increases compared to the normal mode so that the deposition cleaning process is prioritized over combustion characteristics or exhaust characteristics, so that the cleaning performance using fuel which adheres to intake valves 4 is improved.

As a process to increase the amount of fuel adhering to intake valves 4, for example, the following processes A to C may be used.

A: changing of injecting timing of fuel injection valve 3

B: increasing of fuel supply pressure to fuel injection valve 3

C: switching of fuel injection valve

Process A is a process in which the amount of fuel adhering to intake valves 4 increases in a manner such that the injecting timing becomes advanced or delayed than that of the normal mode.

Here, the injecting timing changing direction for increasing the adhering amount varies depending on the size of particles to be sprayed from fuel injection valve 3, that is, the persistence force of fuel spray.

For example, when the fuel spray of fuel injection valve 3 is fuel spray with large particles and strong persistence force, the injecting timing is made advanced so that much fuel is sprayed at the exhaust stroke in which no intake air flow occurs inside intake pipe 2. Since the spray of fuel injection valve 3 is set to be directed toward the umbrella portions of intake valves 4, the fuel spray is directly directed toward the umbrella portions of intake valves 4, and fuel collides with the umbrella portions of intake valves 4, so that much fuel may adhere to intake valves 4.

On the other hand, for example, when the spray is suspended inside intake pipe 2 on the upstream side of intake valves 4 so that the fuel does not adhere to intake valves 4 because the particles of the fuel spray of fuel injection valve 3 are small and the persistence force thereof is weak even when the fuel is injected at the exhaust stroke, the injecting timing is made advanced, so that much fuel is injected at the intake stroke. In this way, since the fuel spray with a weak persistence force is introduced by the intake air flow, much fuel may adhere to the umbrella portions of intake valves 4.

That is, the intake air flow which is generated at the intake stroke flows toward the umbrella portions of intake valves 4, and the fuel spray flows toward intake valves 4 along with the flow. Here, although the intake air is drawn into the cylinder by suddenly changing the direction thereof in the vicinity of the umbrella portions of intake valves 4, since the direction in which spray particles flow do not suddenly changes, the spray particles collide with the umbrella portions of intake valves 4 so as to adhere thereto.

When the fuel spray with a weak persistence force is injected at the exhaust stroke, the fuel spray is suspended at the upstream side of intake valves 4. The fuel spray which is suspended around intake valves 4 is directly drawn into the cylinder when intake valves 4 are opened, so that the fuel spray does not adhere to intake valves 4. Therefore, the fuel adheres to intake valves 4 by giving kinetic energy to the fuel spray directed toward intake valves 4 in a manner such that the fuel is injected into the intake air flow.

As described above, if there is provided fuel injection valve 3 with a strong persistence force in which fuel collides with intake valves 4 when the fuel is injected at the exhaust stroke, in the cleaning mode, the injecting timing is made advanced compared to that of the normal mode, so that more fuel is injected at the exhaust stroke. Accordingly, the amount of fuel adhering to intake valve 4 becomes greater than that of the normal mode, which may improve the capability that the fuel which adheres to intake valves 4 cleans away deposits.

On the other hand, if there is provided fuel injection valve 3 with a weak persistence force in which fuel does not collide with intake valves 4 when the fuel is injected at the exhaust stroke, in the cleaning mode, the injecting timing is made advanced compared to that of the normal mode, so that more fuel is injected at the intake stroke. Accordingly, the amount of fuel adhering to intake valves 4 increases compared to the normal mode, which may improve the capability that the fuel which adheres to intake valves 4 cleans away deposits.

Accordingly, the injecting timing changing direction when switching to the cleaning mode is determined in advance due to the persistence force of fuel spray in fuel injection valve 3 installed in internal combustion engine 1. Furthermore, the advance amount or the delayed amount when advancing or delaying the injecting timing compared to the normal mode is set in consideration of a change in the amount of fuel adhering to intake valves 4 and combustion characteristics, and is set in advance as a timing at which the fuel adhering amount increases while combustion safety is maintained.

Furthermore, in process B, the fuel supply pressure to fuel injection valve 3 is set to be higher than that of the normal mode, so that the persistence force of the fuel spray increases and the amount of fuel adhering to intake valves 4 increases.

An increase in the fuel supply pressure may be achieved by the increasing of target fuel pressure TGFUPR or the setting of target fuel pressure TGFUPR for the cleaning mode. Furthermore, the pressure increase range of the fuel supply pressure with respect to the normal mode is set to a pressure as low as possible within the range in which the deposit cleaning performance may be sufficiently improved.

That is, when the fuel supply pressure is made excessively high, the power consumption of fuel pump 12 increases, and the amount of fuel adhering to intake valves 4 excessively increases, which may degrade combustion characteristics or exhaust characteristics. Therefore, the fuel adhering amount sufficient for cleaning away deposits is obtained, and the pressure increases up to the fuel supply pressure capable of suppressing degradation in combustion characteristics or exhaust characteristics.

Here, the changing of the injecting timing and the increasing of the fuel supply pressure are combined, the fuel supply pressure is set to be higher than that of the normal mode, the persistence force of fuel spray is strengthened, and then fuel is injected at the exhaust stroke by advancing the injecting timing compared to the normal mode.

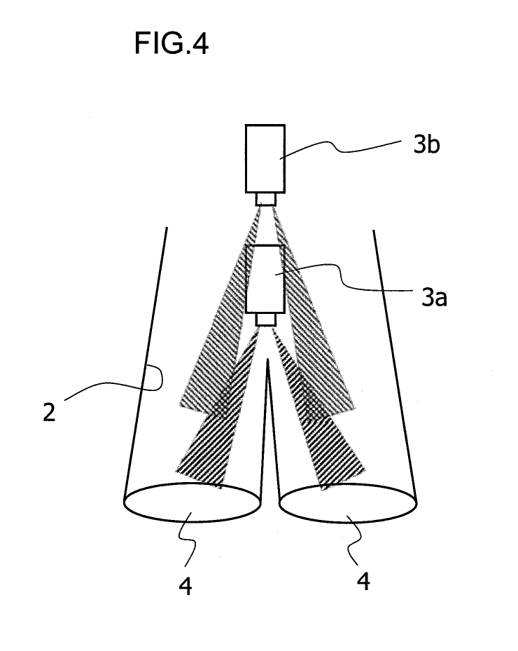

Furthermore, in process C, as fuel injection valve 3, two fuel injection valves 3a and 3b are installed at each engine cylinder as illustrated in FIG. 4, so as to have different amounts of fuel adhering to intake valves 4 due to a difference in the persistence force of the fuel spray. Then, in the normal mode, the fuel is injected by using the fuel injection valve with a relatively small amount of fuel adhering to intake valves 4 among two fuel injection valves 3a and 3b. On the other hand, in the cleaning mode, the fuel is injected by using the fuel injection valve with a relatively large amount of fuel adhering to intake valves 4 among two fuel injection valves 3a and 3b.

Here, at least one of processes A and B may be combined with process C for implementation.

Furthermore, as two fuel injection valves 3a and 3b with different amounts of fuel adhering to intake valves 4, the combination of fuel injecting valves with different persistence forces in accordance with a difference in the injection hole diameter may be used. Furthermore, as the fuel injection valve, the same fuel injection valve may be used, and the persistence force may be made to be different in accordance with a difference in the fuel supply pressure.

Furthermore, in the example illustrated in FIG. 4, each of fuel injection valves 3a and 3b is formed as a two-directional valve. Furthermore, two fuel injection valves 3a and 3b are arranged along the direction of the upstream and downstream of intake pipe 2, but the invention is not limited to such an arrangement.

Moreover, the method of increasing the amount of fuel adhering to intake valves 4 and improving the deposition cleaning performance using fuel which adheres to intake valves 4 is not limited to the above described processes A to C.

For example, in fuel injection valve 3 with a mechanism that supplies air for finely atomizing fuel, fuel is finely atomized with the supply of air in the normal mode, and the particle diameter of fuel spray is enlarged by suspending air supply in the cleaning mode, so that the persistence force of the fuel spray may be strengthened and the amount of fuel adhering to intake valves 4 may be increased.

Furthermore, when the discharge amount of HC increases from internal combustion engine 1 due to an increase in the amount of fuel adhering to intake valves 4 in the cleaning mode, the ignition timing may be made delayed compared to that of the normal mode in order to suppress the discharge amount of HC from internal combustion engine 1.

Furthermore, as a process of improving the deposit cleaning performance using fuel which adheres to intake valves 4 in the cleaning mode, in the cleaning mode, the fuel which is injected from fuel injection valve 3 may be switched to fuel with the higher deposit cleaning performance than that of the normal mode.

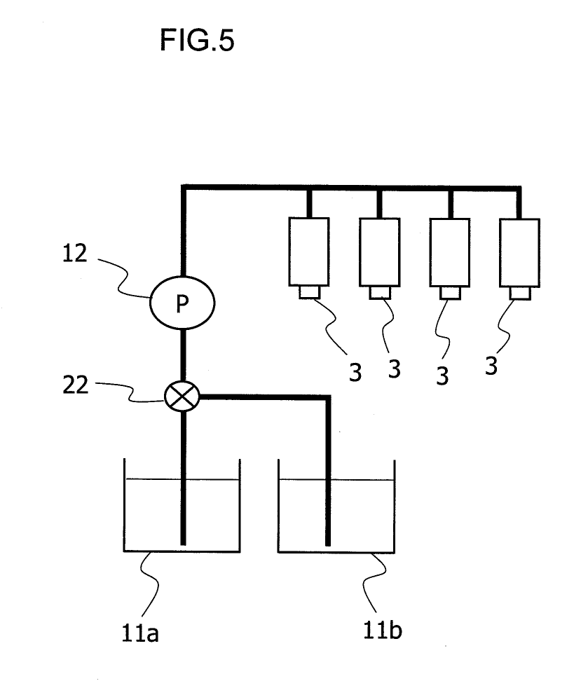

Specifically, for example, as illustrated in FIG. 5, two fuel tanks 11 are provided. Then, one fuel tank 11a stores additive-containing fuel with a deposit cleaning effect, that is, fuel with the higher deposit cleaning performance. The other fuel tank 11b stores fuel which does not contain additives or contains a comparatively low content of additives. Furthermore, the fuel tank in which fuel is pumped by fuel pump 12 may be switched by a valve 22 to any one of fuel tank 11a and fuel tank 11b.

Then, in the normal mode, fuel which does not contain additives or contains a low content of additives and is stored in fuel tank 11b, is pressure-fed to fuel injection valve 3. On the other hand, in the cleaning mode, the additive-containing fuel which includes a cleaning effect and is stored in fuel tank 11a, is pressure-fed to fuel injection valve 3.

As the additives, general additives such as polyetheramines (PEA) or methanol may be used.

In the cleaning mode, when the additive-containing fuel with a cleaning effect is injected from fuel injection valve 3, the deposit in intake valves 4 may be cleaned away and removed by the cleaning force of the additives which are contained in fuel adhering to intake valves 4 even when the amount of fuel adhering to intake valves 4 does not increase.

Furthermore, a tank which stores fuel and a tank which stores additives having a cleaning effect may be provided. Then, in the normal mode, fuel pump 12 pumps fuel up from the tank which stores the fuel. On the other hand, in the cleaning mode, fuel pump 12 pumps fuel up from the tank which stores fuel, pumps additives up from the tank which stores the additives, mixes the fuel and the additives with each other, and then pressure-feeds the resultant to fuel injection valve 3.

Furthermore, a tank which stores fuel and a tank which stores additives having a cleaning effect may be provided. Furthermore, a pump which pressure feeds the fuel toward fuel injection valve 3 and a pump which pressure-feeds the additives toward fuel injection valve 3 may be both provided. Then, the fuel and the additives which are pressure-fed from two pumps may be mixed with each other and be injected from fuel injection valve 3.

Moreover, fuel injection valve 3a which injects fuel that does not contain additives or contains a relatively low content of additives and fuel injection valve 3b which injects additives or additive-containing fuel may be individually provided. Then, in the normal mode, the fuel is injected by using fuel injection valve 3a. On the other hand, in the cleaning mode, fuel which contains additives is injected by using fuel injection valve 3b or both fuel injection valve 3a and fuel injection valve 3b.

Furthermore, in the cleaning mode, the additive-containing fuel with a deposit cleaning effect may be injected from fuel injection valve 3, and the amount in which additive-containing fuel adheres to intake valves 4 may be increased by the changing of the valve timing or the increasing of the fuel pressure. In this way, the higher cleaning effect may be exhibited.

As described above, the normal mode is switched to the cleaning mode with an increase in the deposit amount of intake valves 4, and in the cleaning mode, the deposit cleaning performance using fuel which adheres to intake valves 4 is improved by the increasing of the fuel adhering amount and the switching to fuel with the higher cleaning performance, or one of increasing and switching.

Accordingly, in a state in which the amount of deposition does not increase up to an extent that the deposit needs to be cleaned away, fuel which is superior in combustion characteristics, fuel efficiency, and exhaust characteristics may be injected. In a state in which the amount of deposition increases up to an extent that the deposit needs to be cleaned away, the cleaning away of the deposit is promoted, thereby suppressing the excessive increase in the amount of the deposit in intake valves 4.

Furthermore, when the amount of fuel adhering to intake valves 4 increases, and particularly, the amount of fuel adhering to intake valves 4 is changed by changing the injecting timing or the fuel supply pressure, it is possible to control the amount of fuel adhering to intake valves 4 in accordance with the deposition amount without changing a device constituting internal combustion engine 1.

Furthermore, when the fuel which is injected from fuel injection valve 3 is changed to fuel with the higher cleaning performance, the deposit cleaning performance may be further reliably improved, the cleaning of the deposit in intake valves 4 may be promoted, and the unnecessary use of detergent may be suppressed by using additives within a limited time during which the cleaning process is performed.

Incidentally, in a state in which the deposition amount is large at the early stage of switching to the cleaning mode, the opening area which is formed between intake valves 4 and the cylinder head when intake valves 4 are opened is narrowed by the deposit, which may reduce the air intake amount into the cylinder.

Therefore, in internal combustion engine 1 with variable valve mechanism 22 that may change the degree of the valve opening of intake valves 4, when it is determined that deposition amount VDEPO is equal to or greater than second threshold value SL2 in step S400 of the flowchart of FIG. 2 and the current process proceeds to step S500, the degree of the opening of intake valves 4 may be changed by variable valve mechanism 22 in a direction in which the air intake amount into the cylinder increases together with the switching to the cleaning mode or instead of the switching to the cleaning mode.

When variable valve mechanism 22 is a mechanism that continuously or gradually changes the maximal valve lift amount of intake valves 4, if deposition amount VDEPO becomes equal to or greater than second threshold value SL2, the maximal valve lift amount of intake valves 4 is increased compared to the normal mode, so that the portion which may be narrowed by the deposit in the opening area of intake valves 4 may be complemented and the air intake amount into the cylinder may be ensured.

Furthermore, when variable valve mechanism 22 is a mechanism that continuously or gradually changes the central phase of the operation angle of intake valves 4 in a manner such that the rotation phase of the intake cam shaft with respect to the crank shaft is changeable, the actual closing timing is made closer to the closing timing at which the maximal charging efficiency is obtained, so that the portion which may be narrowed by the deposit in the opening area of intake valves 4 may be complemented and the air intake amount into the cylinder may be ensured.

The entire contents of Japanese Patent Application NO. 2011-193769, filed Sep. 6, 2011 are incorporated herein by reference.

While only a select embodiment has been chosen to illustrate the present invention, it will be apparent to those skilled in the art from this disclosure that various change and modification can be made herein without departing from the scope of the invention as defined in the appended claims.

Furthermore, the foregoing description of the embodiment according to the present invention are provided for illustration only, and not for the purpose of limiting the invention, the invention as claimed in the appended claims and their equivalents.

What is claimed is:

1. A control apparatus for an internal combustion engine including intake valves and a fuel injection valve injecting fuel into an intake pipe on the upstream side of the intake valves, the control apparatus comprising:
an estimation unit that estimates a deposition amount of the intake valves based on an operation state of the internal combustion engine; and
a control unit that improves deposit cleaning performance using the fuel with an increase in the deposit amount estimated by the estimation unit.

2. The control apparatus for an internal combustion engine according to claim 1,
wherein when the deposit amount becomes greater than a threshold value, the control unit improves the cleaning performance compared to the case in which the deposit amount is less than the threshold value.

3. The control apparatus for an internal combustion engine according to claim 1,
wherein the control unit improves the cleaning performance by increasing an amount of fuel adhering to the intake valves.

4. The control apparatus for an internal combustion engine according to claim 3,
wherein the control unit increases the amount of fuel adhering to the intake valves by changing the injecting timing of the fuel injection valve.

5. The control apparatus for an internal combustion engine according to claim 4,
wherein the control unit determines whether the injecting timing of the fuel injection valve is made advanced or delayed with respect to an increase in the deposition amount in accordance with the persistence force of fuel spray of the fuel injection valve.

6. The control apparatus for an internal combustion engine according to claim 3,
wherein the control unit increases the amount of fuel adhering to the intake valves by changing a pressure of fuel supplied to the fuel injection valve.

7. The control apparatus for an internal combustion engine according to claim 3,
wherein the internal combustion engine includes a plurality of fuel injection valves with different amounts of fuel adhering to the intake valves for the respective engine cylinders, and
wherein the control unit increases the amount of fuel adhering to the intake valves by selecting the fuel injection valve for injecting fuel among the plurality of fuel injection valves.

8. The control apparatus for an internal combustion engine according to claim 7,
wherein the plurality of fuel injection valves is a plurality of fuel injection valves with different persistence forces of fuel spray.

9. The control apparatus for an internal combustion engine according to claim 1,
wherein the control unit improves the cleaning performance by changing fuel which is injected by the fuel injection valve.

10. The control apparatus for an internal combustion engine according to claim 9,
wherein the internal combustion engine includes two fuel tanks that store two types of fuel with different cleaning performances, and
wherein the control unit selects any one of the two fuel tanks based on the deposition amount, and pressure-feeds the fuel which is stored in the selected fuel tank to the fuel injection valve.

11. The control apparatus for an internal combustion engine according to claim 1,
wherein the estimation unit estimates the deposition amount based on the amount of a gas blown back to the intake pipe and the temperature of the gas blown back to the intake pipe.

12. The control apparatus for an internal combustion engine according to claim 1,
wherein the internal combustion engine includes a variable valve mechanism that changes the valve timing of the intake valves, and
wherein the estimation unit estimates the deposition amount based on the load of the internal combustion engine, the rotation speed of the internal combustion engine, and the valve timing of the intake valves changed by the variable valve mechanism.

13. A control apparatus for an internal combustion engine including intake valves and a fuel injection valve injecting fuel into an intake pipe on the upstream side of the intake valves, the control apparatus comprising:
an estimation means that estimates a deposition amount in the intake valves based on an operation state of the internal combustion engine; and
a control means that improves deposit cleaning performance using the fuel with an increase in the deposition amount estimated by the estimation means.

14. A control method for an internal combustion engine including intake valves and a fuel injection valve injecting fuel into an intake pipe on the upstream side of the intake valves, the control method comprising:
estimating a deposition amount in the intake valves based on an operation state of the internal combustion engine; and
improving deposit cleaning performance using the fuel with an increase in the deposition amount.

15. The control method for the internal combustion engine according to claim 14,
wherein the improving of the cleaning performance includes
comparing the deposition amount with a threshold value, and
improving the cleaning performance when the deposition amount becomes greater than the threshold value compared to the case in which the deposition amount is less than the threshold value.

16. The control method for an internal combustion engine according to claim 14,
wherein the improving of the cleaning performance includes
improving the cleaning performance by increasing the amount of fuel adhering to the intake valves.

17. The control method for an internal combustion engine according to claim 16,
wherein the increasing of the amount of fuel adhering to the intake valves includes
increasing the amount of fuel adhering to the intake valves by changing the injecting timing of the fuel injection valve.

18. The control method for an internal combustion engine according to claim 14,
wherein the improvement of the cleaning performance includes
improving the cleaning performance by changing fuel which is injected by the fuel injection valve.

19. The control method for an internal combustion engine according to claim 14,
wherein the estimating of the deposition amount includes
detecting the amount of a gas blown back to the intake pipe,
detecting the temperature of the gas blown back to the intake pipe, and
estimating the deposition amount based on the amount and the temperature of the blown-back gas.

20. The control method for an internal combustion engine according to claim 14,
wherein the internal combustion engine includes a variable valve mechanism that changes the valve timing of the intake valves, and
wherein the estimating of the deposition amount includes
detecting the load of the internal combustion engine,
detecting the rotation speed of the internal combustion engine,
detecting the valve timing of the intake valves which is changeable by the variable valve mechanism, and
estimating the deposition amount based on the load of the internal combustion engine, the rotation speed of the internal combustion engine, and the valve timing of the intake valves.
